(19) United States
(12) Patent Application Publication
(10) Pub. No.: US 2018/0075390 A1
(43) Pub. Date: Mar. 15, 2018

(54) MANAGEMENT METHOD AND SYSTEM

(71) Applicant: MOTIVII LIMITED, London, Greater London (GB)

(72) Inventor: Eamon TUHAMI, London (GB)

(21) Appl. No.: 15/565,708

(22) PCT Filed: Apr. 11, 2016
(86) PCT No.: PCT/GB2016/051012

§ 371 Date: Oct. 11, 2017

Related U.S. Application Data
(60) Provisional application No. 62/146,509, filed on Apr. 13, 2015.

(51) Int. Cl. G06Q 10/06; G06F 3/0482; G06F 3/0488

(52) U.S. Cl. CPC G06Q 10/06393; G06Q 10/06395; G06F 3/04883; G06F 3/0482; G06Q 10/06398

(57) ABSTRACT

The present invention relates to a computer-implemented method of providing a management tool. The method includes capturing a motivation value from each of a plurality of users and processing the captured motivation values with data from one or more data sources to generate correlation information. A system is also disclosed.

### FIELD OF INVENTION

The present invention is in the field of management. More particularly, but not exclusively, the present invention relates to a method and system for generating intelligence (such as business intelligence) by monitoring and analysing motivation data provided by individuals (e.g. employees).

### BACKGROUND

Companies traditionally focus on Key Performance Metrics (KPI's), such as forecasting profitability, future sales, and turnover, to manage their business.

Employees are a core asset that a business has to influence these metrics.

Businesses monitor employees via managers. Managers may require members of their team to deliver regular reports on their tasks. Managers process this information to be able to deliver reports on their team to their own manager. Eventually, with the filtering and summarisation of reports, at the top level, the business has a view of their employees.

Unfortunately, this process does not provide a standardised view and does not help managers or the business to identify systemic issues or their causes.

Another mechanism utilised by businesses are employee surveys.

A traditional employee survey attempts to determine how employees are feeling and what they think about the business. Typically the surveys take place annually and take some time by each employee to fill in—more than 10 minutes.

The advantage of this method is a standardised process, but the disadvantage is that the surveys are cumbersome to administer and provide limited insight into the business.

An improved employee survey is called a pulse survey (such as provided by TinyPulse.com). This is similar to traditional surveys but differs by asking more, but smaller questions, throughout the year and at key times.

An alternative method of monitoring employees is an employee feedback system (such as 15five.com or Idonethis.com).

These systems automate a traditional employee reporting system.

The disadvantages with all the prior art is that they do not leverage coincident data to deliver intelligence at a business-wide level or at a team level. Furthermore, none of the prior art describes a standardised method to measure the motivation levels of employees.

It is an object of the present invention to provide a management method and system which overcomes the disadvantages of the prior art, or at least provides a useful alternative.

### SUMMARY OF INVENTION

According to a first aspect of the invention there is provided a computer-implemented method of providing a management tool, including:

Capturing a motivation value from each of a plurality of users via a user device; and

At least one processor processing the captured motivation values with data from one or more data sources to generate correlation information.

The motivation values may be captured periodically.

The motivation values may be captured every week.

The user device may be a mobile user device and may include a touch-screen. The motivation values may be captured by a mobile application executing on the mobile user device.

A user may be given a predefined window within which to provide the motivation value.

The motivation values may be within a predefined range.

The method may further include the step of: at the time of capturing the motivation value, capturing specific information relating to the user's tasks via the user device. The specific information may include answers to predefined questions. The questions may be the same questions for each user. The questions may include questions relating highlights of a time period, challenges for the time period, and focus for the following time period. The specific information may be aggregated and sent to one or more managers of the user.

At least some of the users are employees of a company. The data from the one or more data sources may be key performance indicators for the company. The method may further include the step of: providing the correlated information to one or more managers within the company. The employees may link the company to their motivation values to enable correlated information relating to their captured motivations values to be provided to their managers. The employees may link the company using an activation code provided by the company or by using a manager's email. The motivation values may be anonymised before being provided to the one or more managers. Each manager may head a team of which the employees are members. Correlation information relating to the manager's team may be provided to the manager. The data may include team data.

At least one of the data sources may be an external data source.

At least one of the data sources may be a data source from a company of which at least some of the users are employees.

One of the data sources may be the user device.

At least some of the data from the one or more data sources may be global/national data. The global data may be one or more selected from financial information and news stories.

At least some of the data from the one or more data sources may be local data. The local data may be one or more selected from weather, transport, and date.

At least some of the data from the one or more data sources may be user specific data. The user specific data may be one or more selected from fitness data and geolocation data.

The method may further include the steps of: capturing calibration data from each user in relation to their motivation and/or using the calibration data to generate a model for each user and/or analysing each captured motivation value in relation to the model for the user to detect erroneous values.

The method may further include the step of: prior to processing, normalising the motivation values. The step of normalising the motivation values may utilise the calibration data and/or historical motivation values.

The user devices may receive the motivation value via a user interface mechanism at the user device. The user interface mechanism may be a gauge.

The method may further include the step of: providing the correlation information to the user.

The method may further include the step of: providing historical motivation values for a user to a user.

The method may further include the step of: at the time of capturing the motivation value, capturing information relating to the motivation value from the user via the user device.

The information may be captured from the user via a text entry interface mechanism at the user device.

The method may further include the step of: at the time of capturing the motivation value, capturing an answer to specific question from the user at the user device. The question may be a multi-choice question or a binary question. The method may further include the step of: clustering the users using answers to the specific question to facilitate generation of the correlation information.

The data from the one or more data sources may be periodically retrieved by the at least one processor.

The motivation values may be stored within a database. The stored motivation values may be associated with a timestamp of capture.

Users may be assigned to one or more groups. The groups may be based upon the user's role, the user's team within a company, or a location of the user.

The method may further include the step of: pre-processing the data retrieved from the one or more data sources before use in generating correlation information. The pre-processing may include normalising the data, generating a quantitative time series, and/or aligning the data.

According to a further aspect of the invention there is provided a system for providing a management tool, including:

A plurality of user devices, each device configured to capture motivation values from a user;

At least one processor configured to process the captured motivation values with data from one or more data sources to generate correlation information; and

At least one memory store configured to store the captured motivation values.

The system may include a manager user device configured to display correlation information to a manager of one or more of the users.

The system may also include at least one communication module configured for retrieving at least some of the data from one or more external data sources.

According to a further aspect of the invention there is provided a computer-implemented method of providing a management tool, including:

Capturing a motivation value from each of a plurality of users via a user device;

At least one processor normalising the motivation value for each user utilising calibration information previously provided by that user; and

At least one processor processing the normalised motivation values to generate analysis.

According to a further aspect of the invention there is provided a system for providing a management tool, including:

A plurality of user devices, each device configured to capture motivation values from a user;

At least one processor configured to normalise the motivation value for each user utilising calibration information previously provided by that user and to process the normalised motivation values to generate analysis; and

At least one memory store configured to store the normalised motivation values.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIGS. 3a and 3b:
show a flow diagram illustrating a method and system in accordance with an embodiment of the invention;

FIGS. 4a, 4b, and 4c:
show screenshots illustrating different user interface mechanisms for use in a system in accordance with an embodiment of the invention;

FIGS. 5a, 5b, and 5c:
show screenshots illustrating the capture of notes for a motivation value in accordance with an embodiment of the invention;

FIGS. 6a, 6b, 6c, 6d, and 6e:
show screenshots illustrating the capture of specific information relating to an employee's tasks in accordance with an embodiment of the invention;

FIGS. 7a and 7b:
show screenshots illustrating the posing and answering of a binary question in accordance with an embodiment of the invention.

FIGS. 8a, 8b, 8c, and 8d:
show screenshots illustrating the calibration for a user in accordance with an embodiment of the invention;

FIG. 9:
show a flow diagram illustrating a method in accordance with an embodiment of the invention;

FIGS. 10a, 10b, 10c, and 10d:
show screenshots illustrating the display of analysis/information to a user based upon their entered motivation values in accordance with an embodiment of the invention; and

FIG. 11: shows a diagram illustrating the display of analysis/information to a manager based upon motivation values provided in accordance with an embodiment of the invention.

### DETAILED DESCRIPTION OF PREFERRED EMBODIMENTS

The present invention provides a method and system for providing a management tool. The management tool may be used, for example, to assist managers, employees, or users.

The inventor has determined that a motivated team is more likely to exceed business KPI's, whereas an unmotivated team is unlikely to achieve them. If a business was able to understand the motivational levels of their teams they would be able to better predict future business performance and importantly focus on the elements that affect motivation and therefore increase business performance.

The inventor has discovered that motivational values can be captured from employees and can be analysed and/or correlated with other data to produce insight for businesses.

The inventor also notes that motivational insight may also be useful for any user, for example, to improve their own motivation.

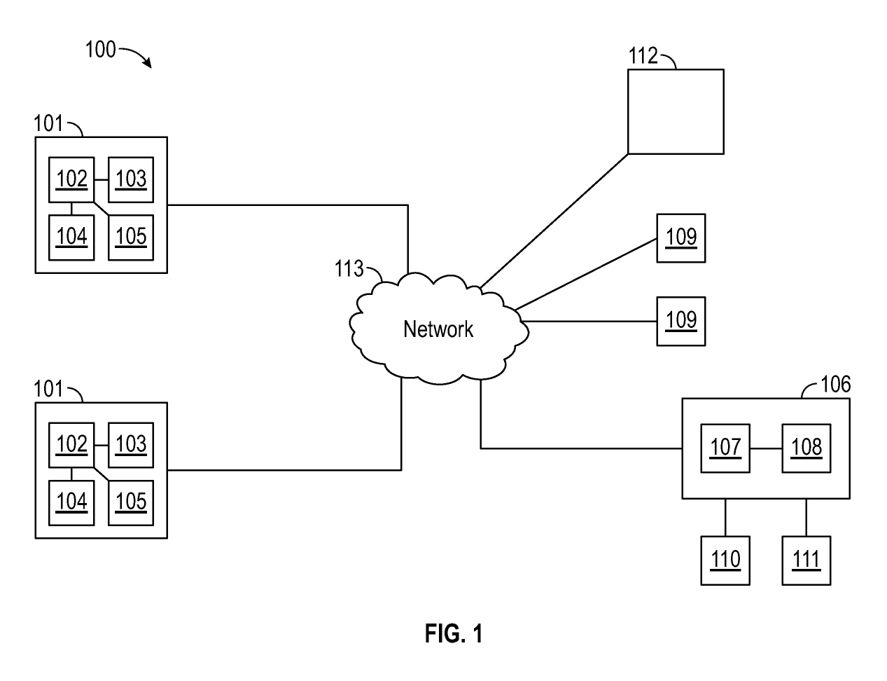

In FIG. 1, a system 100 for providing a management tool in accordance with an embodiment of the invention is shown.

A plurality of user devices 101 are shown. Each device 101 may include a processor 102, an input 103, a display 104, and a communications module 105. The user device 101 may be a mobile device such as a tablet, smart-phone, or smart-watch.

A server 106 is also shown. The server 106 may include a processor 107, and a communications module 108.

A plurality of external data sources 109 is shown. The data sources 109 may be, for example, a weather server for transmitting weather reports, a transport server for transmitting information about transport, and a fitness server for transmitting information about physical activity of a user (for example, from a personal fitness device such as a FitBit).

A memory store 110 is shown. The memory store 110 may be configured to store a database of captured motivation values.

A second memory store 111 is shown. The second memory store 111 may be configured to store a database of data retrieved from a plurality of data sources such as 109.

A manager user device 112 is shown. The manager user device 112 may include a processor, a display, and a communications module.

A network 113 or combination of networks may be used for interconnecting one or more of the user devices 101, server 106, external data sources 109, and manager user device 112.

Each user device 101 may be configured for capturing from a user a motivation value, specific information relating to the user's tasks, and answers to predefined multi-choice/binary questions. The captured information may be transmitted using the communications module 105 at the user device 101 via a communications network 113 to the server 106.

The server 106 may be configured for receiving the motivation values, processing the values to normalise them, and storing them within the first memory store 110. The server 106 may also be configured for retrieving data from a plurality of data sources which may include the external data sources 109, internal data sources, or the user devices 101. The data may be retrieved and stored within the second memory store 111. The server 106 may be configured for processing the retrieved data to normalise it. The server 106 may utilise the communications module 108 to receive data from the external data sources 109.

The server 106 may be further configured to process the motivation values and the retrieved data to generate correlation information and/or analysis. At least some of the correlation information/analysis may be provided back to the user devices 101 or to the manager user device 112. For example, the user devices 101 may receive correlation information/analysis related to the user's motivation values and the manager user device 112 may receive correlation information/analysis related to the manager's team's motivation values.

The manager user device 112 may be configured for displaying the correlation information/analysis.

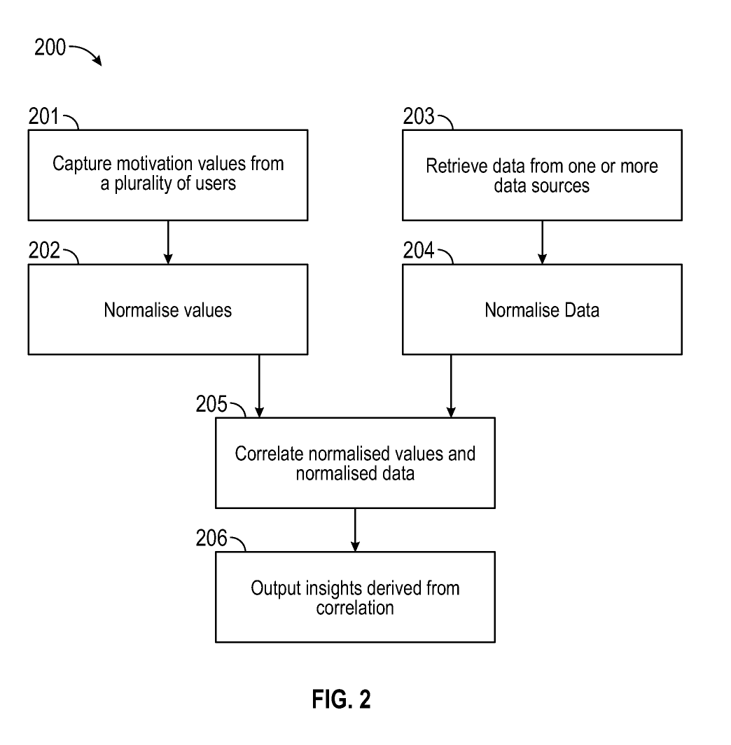

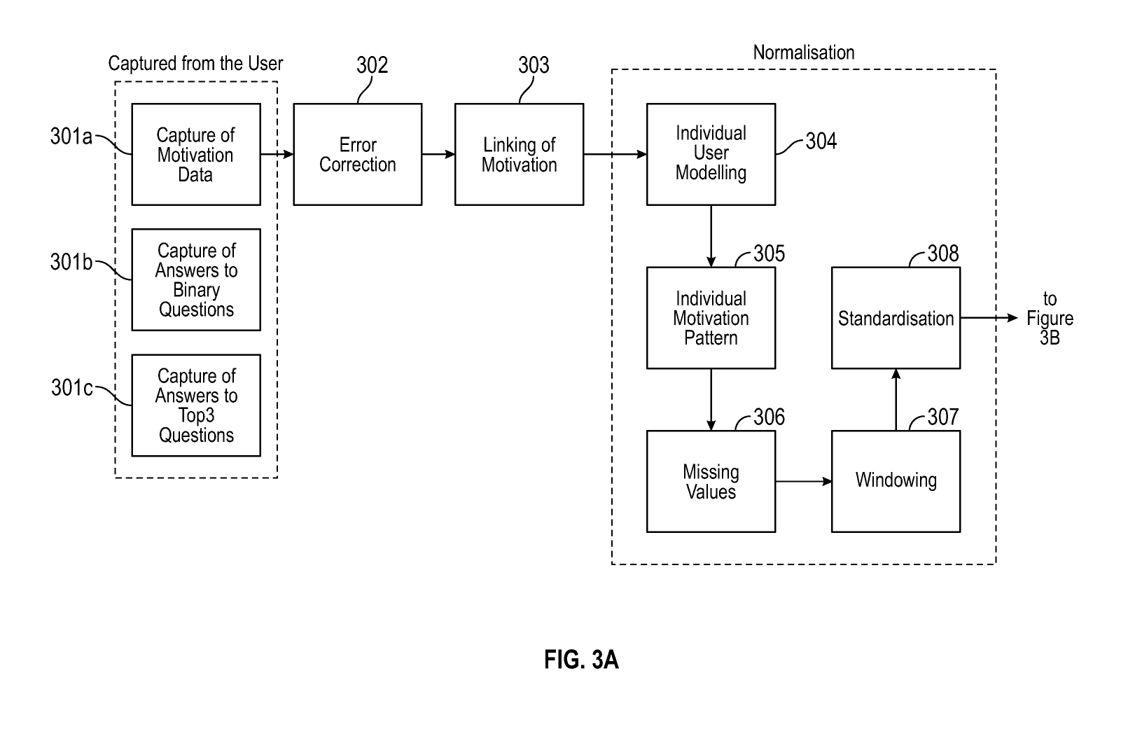

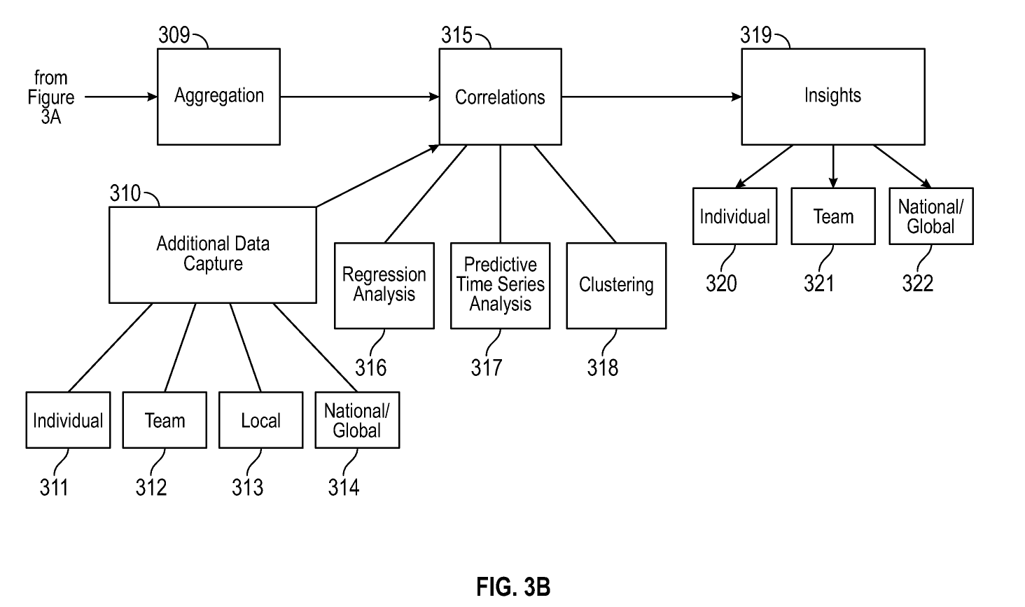

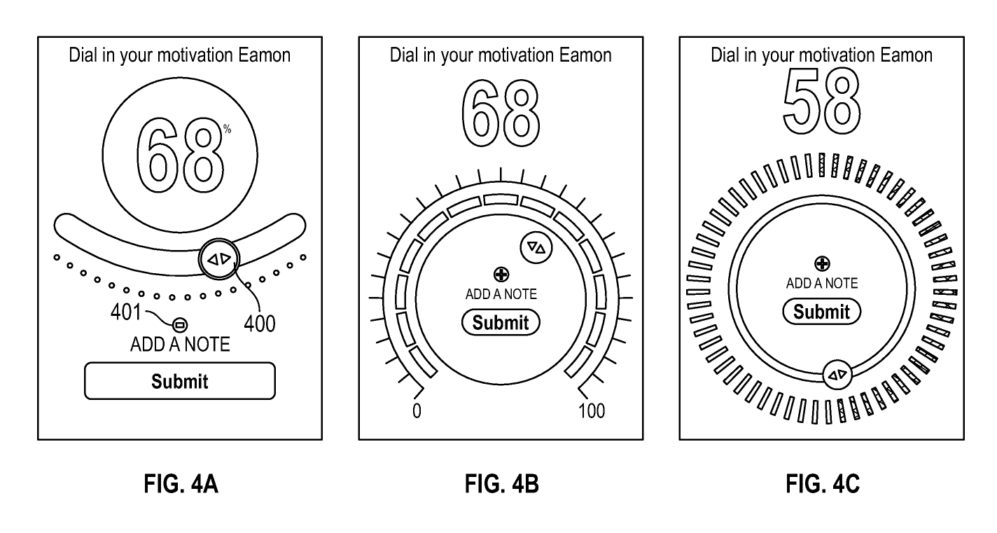

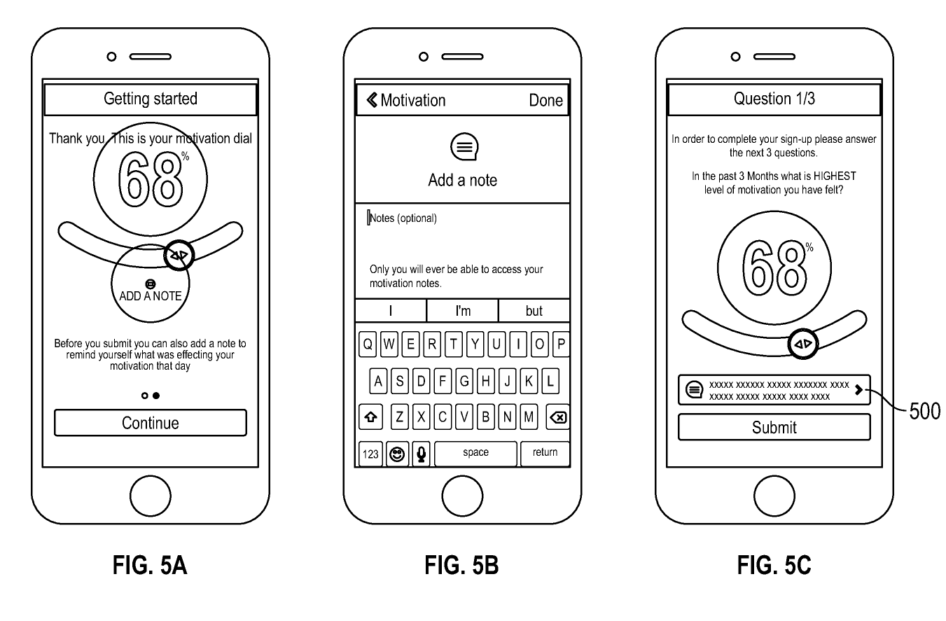

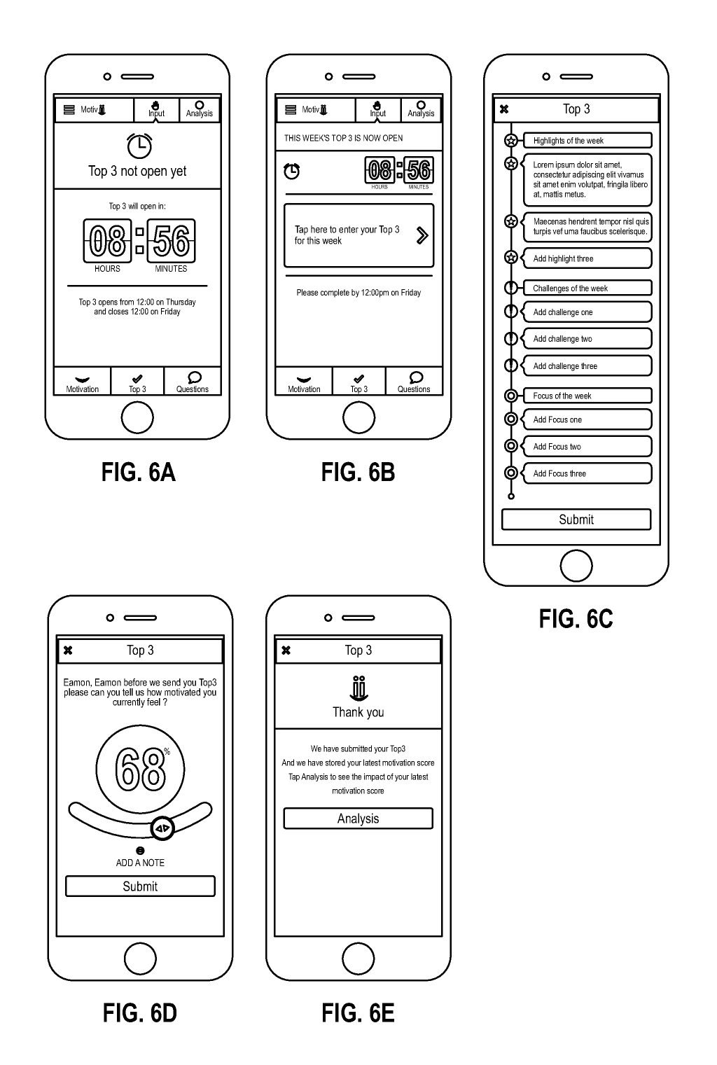

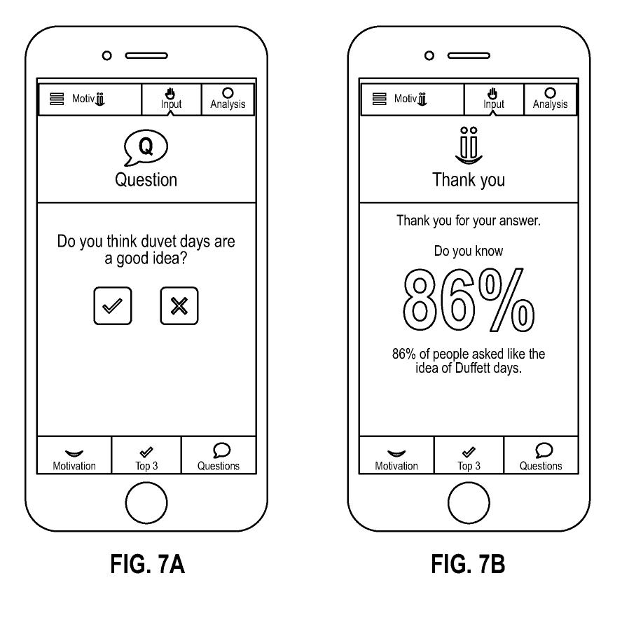

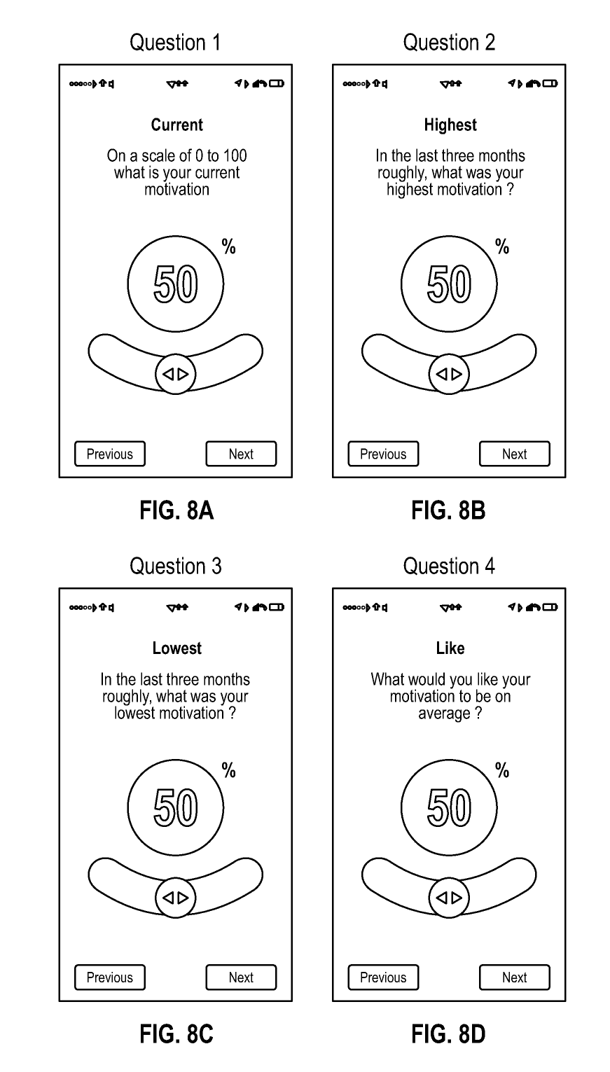

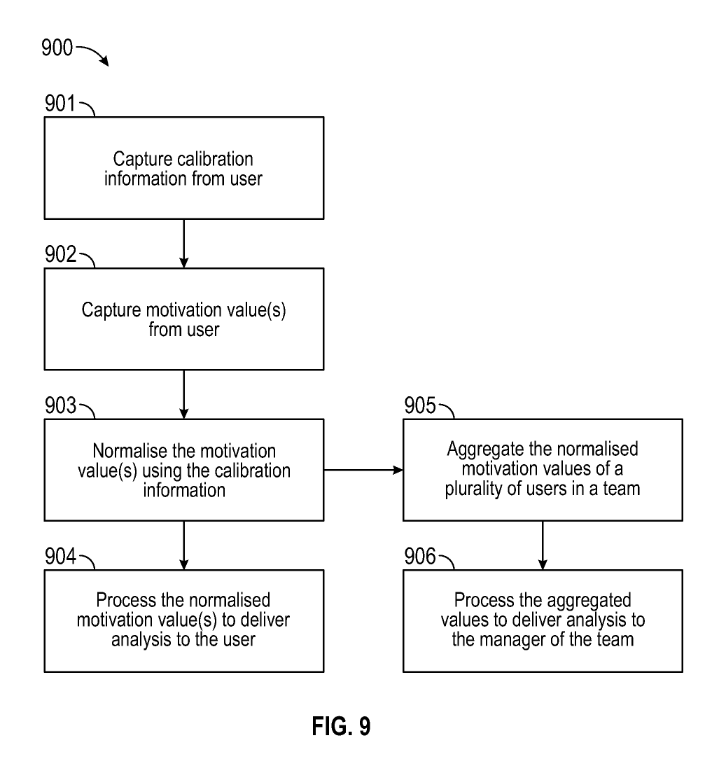

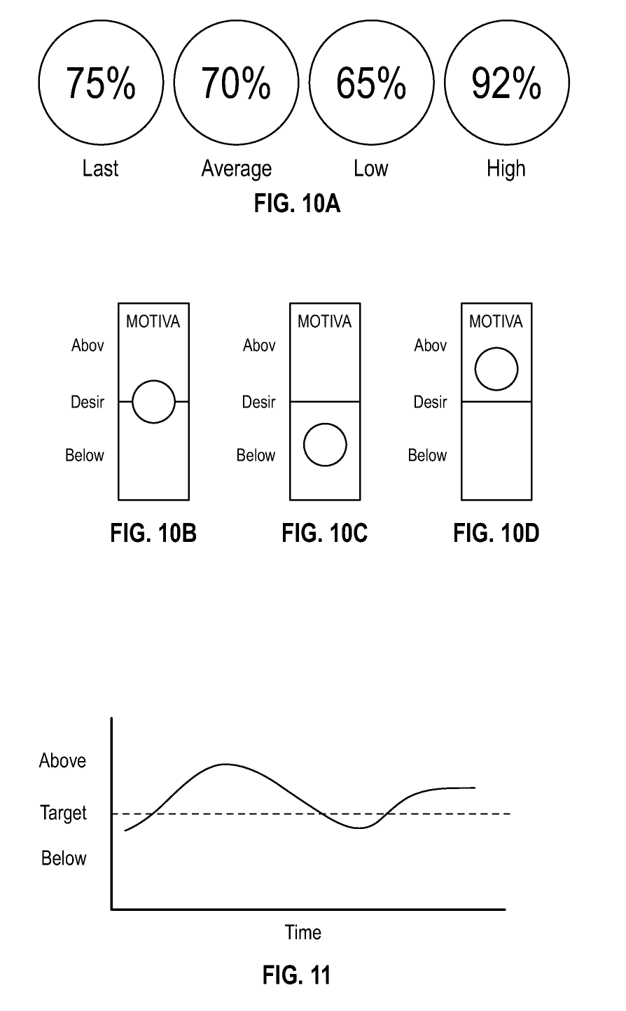

Referring to FIG. 2, a method 200 for providing a management tool in accordance with an embodiment of the invention will be described.

In step 201, a motivation value is captured at a user device for each of a plurality of users. The user device may be executing a mobile application, and the mobile application may display a graphical user interface (GUI) for capturing the motivation values. The GUI may utilise a gauge or dial to receive the user's input as a value for their motivation within a predefined range.

When the motivation value is captured, further information may also be captured from the user, for example, prior to, after or before and after capture of the motivation value. This further information may include notes relating to the motivation value, specific information relating to the user's tasks, and answers to multi-choice/binary questions.

The notes may be information that the user considers relevant to their motivation value or information about what is happening at the time the value is captured (e.g. “company away-day”, “pay-day”, or “moved office location”).

The specific information may be requested from the user by prompting the user to answer questions, such as (“what are your highlights of the week”, “what are your challenges for the week”, and “what is your focus for next week”). The user device may provide a text-box user interface element to receive the specific information from the user. The inventor has discovered that requesting specific information relating to the user's tasks may help focus a user's mind such that when they then provide their motivation value, the value is more likely to be relevant to the user's tasks (and, therefore, employment where those tasks are employment-related). Such focussing can provide more useful data for managers, for example, of those users.

The user device may prompt the user to provide a motivation value (and the further information). This prompting may be scheduled such that periodic capture of a user's motivation values occurs. The inventor has discovered that capturing motivation values periodically (such as weekly) can provide useful information to assist in analysing a user's changing motivation.

The user device may prompt the user by starting a time window within which the user can provide their motivation value for a time period. For example, a 12-hour window may be permitted for a user to provide their motivation value for a one week time period.

A time-stamp for the motivation value may be recorded when the motivation value is captured to facilitate correlation with time-based events.

In step 202, the motivation values are normalised. This normalisation process may utilise calibration data captured earlier from the user. An example of a calibration process will be later described in relation to FIGS. 8a to 8d.

The normalisation process may generate a model for the user based upon calibration data received from the user when the user first accesses the system, and historic motivation values captured from the user.

In step 203, data is retrieved from one or more data sources. At least some of the data sources may be external data source such as weather data sources to retrieve rain, sun, daylight hours, pollen data, etc; fitness data sources, to retrieve fitness tracking data such as from RunKeeper or Strava; or travel data sources, to retrieve data such as from TripIt or the TFL (Transport for London) API. At least some of the data may be retrieved periodically and stored.

The data may be time-stamped to facilitate time-based correlations with motivation values.

In step 204, after retrieval of the data, the data may be normalised. This normalisation process may involve construction of quantitative time series from events and data alignment with periodic motivation capture (i.e. to align time of the data with the time of motivation value capture).

In step 205, the motivation values and the retrieved data is processed to generate correlation information. Various correlation methodologies may be utilised, including regression analysis, predictive time series analysis, and clustering.

Where answers to multi-choice/binary questions are provided, users may be clustered based on their answers to augment analysis.

In step 206, at least part of the resulting correlation information may be displayed to the user at their user device or to a manager of the user.

For example, the resulting correlation information may be displayed as statement or conclusions, such as, for users:
Did you know that when the clocks change your motivation dips by 10%.
Your average motivation is 5% higher than your company's average.
Your motivation in the summer months is more stable than the winter months.
When you come back from holiday your motivation is 20% higher than normal, though this effect only lasts for three weeks.
Your motivation increases in weeks when you get to work early
You are below your desired motivation level

Or for managers:
This week motivation is high.
Towards the end of the week your team's motivation is higher.
Your team is above their desired motivation level
Your New York office's motivation is improving more than your London office

The user may be associated with one or more groups. For example, the user may be associated with a team. The manager of the team may be provided with at least part of the resulting correlation information.

In one embodiment, at least some of the users are employees at a company, and the correlation information relating to those users is provided to their managers at that company. The correlation information provide to a manager may relate to motivation data aggregated from every member within a manager's team, such that an individual's motivation data is effectively anonymised.

Referring to FIGS. 3a and 3b, a method and system in accordance with an embodiment of the invention will be described.

The system may include an app or user interface executing or provided on a user device, one or more processors at one or more servers, and one or more databases.

### Capture and Storage of Motivation Data (Step 301a)

A motivation recording is captured within an app or user interface, and stored in a database. This may be done through the use of an Application Programming Interface (API) which is exposed over the network, for example, to mobile applications executing on user devices.

The motivation score, that is, the value that the user selected as to how motivated they are, along with a unique identifier for the user and the timestamp of the recorded motivation value would be stored, this will be referred to as Motivation Data. The motivation score would be selected from a finite range.

Some Additional Data (as described later in this document) may also be collected at this point, such as geolocation data (latitude, longitude, altitude), device data (accelerometer sensor, wifi network name, etc), and other data that may be available at point of capture of motivation.

User generated notes may also be stored within the Motivation Data. These notes give the user the ability to say why they selected the value they selected for their motivation.

Before, during or after the motivation score is captured from the user, the user may be prompted to provide answers to binary Questions 301b or provide feedback to Top3 questions 301c. Top3 questions are questions which request the user's top three highlights and challenges for the week, and the user's top three goals for the following week. Both binary questions and Top3 questions are described in greater detail later within this document.

An example of Motivation Data as a JavaScript Object Notation (JSON) representation is given below:

```
{
  user_id: ″d924ce56-4493-4337-8770-1d697050003b″,
  timestamp: 1424197076000,
  score: integer(0-100),
  note: “lorem ipsum dolor sit amet“
}
```

### Error Detection/Correction (Step 302)

As detailed later in this document a model is fitted for each user. If the user provides a value which their model suggests is particularly unlikely (for example less than a 1% probability of occurrence), the app could ask the user to confirm their entry.

### Linking of Motivation (Step 303)

Individual users can be associated by the use of groupings. These groupings can either be derived from data stored by the system (such as geographic location data) or via users grouping themselves into user generated groups. Some examples of these groups may include:
Teams
Companies or Organisations
Divisions
Roles
Cities, Countries and other Localities

These groups could also be inferred by the system.

By associating individuals to groups, further analysis can be done to provide alternative aggregate group views of motivation. This analysis can then be provided back to the individual or be anonymously shared with the rest of the group. When leaving a team or company an individual user can unlink with where they work and link to their new place of work.

In one embodiment, no motivation data is actually stored within these groups. Therefore, if a user leaves a group their individual motivation data will no longer continue to contribute to that group's motivation data. The system may also store information about when a user joins and leaves user generated groups, for example, data is stored that indicates “John has joined the team Marketing” and “John has left the team Marketing” along with the timestamps at which this change took place. The data for one of these events might be represented in JSON as:

```
{
  user_id: ″d924ce56-4493-4337-8770-1d697050003b″,
  timestamp: 1424197076000,
  model: ”team”,
  event: ”join”,
  related_id: ”5d1f1f22-d182-48de-8918-6ce0395f0f67”
}
```

### Individual User Modelling (Step 304)

The app can deliver insight in relation to their motivation back to individual users in a short space of time, while at the same time capturing a broad outline of motivational variables that allows it to quickly analyse in relation to other groups. The app may be able to accomplish this by asking calibration questions when an individual user logs in for the first time. The system may attempt to understand one or more of the following:
Current motivation—direct recording.
Average motivation—both computed by the system (empirically) and the subjective estimation of an individual user.
Motivational range—how big is the user's average range of motivation recording?
Propensity to swing—how does the user's motivation swing within this range?
Motivation aspiration—where would the user like their motivation to be?
Highest motivation reading—the user's highest recording or estimation of highest level.
Lowest motivation reading—the user's lowest recording or estimation of lowest level.
Interpretation of Motivation—what average (or any other number within the range) means to the user as an individual?

For the purposes of analysis the system can fit a model for each individual user; for example a normal distribution with mean μ and standard deviation σ (although a more sophisticated model which takes account of generally observed features of self reported motivation could also be used). With sufficient data fitting such a model is straightforward via calculation of the sample mean and standard deviation:

$$μ = \frac{{\sum }_{i} {x}_{i}}{n}$$

$$σ = \sqrt{\frac{1}{n + 1} {\sum }_{i} {( {x}_{i} - μ )}^{2}}$$

However, the system can also provide analysis and information immediately. To address this, the user may be asked to answer a few simple questions on first use, e.g.:

“Where do you feel your current motivation is?”

“In the past three months what is the highest motivation you have felt?”

“In the past three months what is the lowest motivation you have felt?”

Additionally to address the target motivation issues, the following question may be asked:

“Where would you like your motivation to be?”

The current motivation provides us with an estimate of μ. If the high motivation is h, the low motivation l, then an estimate of σ could be obtained by:

σ=(h−l)÷k

where initially, for example, k=4 and later, through the gathering of data from other users, estimating this data by relating their empirical motivation distribution to their original estimates of low and high.

Once additional motivation readings are received from a user the estimate for their mean and standard deviation can be updated using a learning process. For example, assuming the system has new estimates of a model parameter, instead of just accepting this the model moves in the direction of this new estimate (where a controls the strength of convergence). The new estimate might be a relatively computationally light approximation based on recent data, for example:

$${\tilde{x}}_{t + 1} = {\tilde{x}}_{t} + \frac{{x}_{t + 1} - {\tilde{x}}_{t}}{α}$$

### Individual Motivation Pattern (Step 305)

Once the system has collected time series data on motivation for a few months, the system can look at windowed subsections of the time series and for each section estimate, for example, a mean and standard deviation; assuming windows are labelled t and each has a set of data points T:

$${μ}_{t} = \frac{{\sum }_{i ∈ T} {x}_{i}}{\vert T \vert}$$

$${σ}_{t} = \sqrt{\frac{1}{\vert T \vert + 1} {\sum }_{i ∈ T} {( {x}_{i} - μ )}^{2}}$$

This provides a new time series which can provide insights to the user about how their motivation is varying over time (not just the absolute value, but how variable it is). The size of the window can be tuned allowing the trading off of robustness and resolution.

### Missing Values (Step 306)

If individuals may miss motivation recordings or for the purposes of analysis in conjunction with finer grained additional data (see below) the system may generate replacement values. Approaches to accomplish include simply filling in these values forwards, backwards or taking a linear interpolation of the values on either side.

The system may, where team data is available, do something more sophisticated by estimating the missing values based on the recorded motivation of the other members of the team (scaling via the inverse of the process described in standardisation below). Subsequent analysis may have to take account of the fact that some values have been inferred from other team member's data; in particular any team conclusions may be less certain than first appears (as they are based on less data).

### Windowing (Step 307)

As the frequency of motivation records may vary (for example in one week a user may record their motivation 20 times, in another week once; in this case it is undesirable to give equal weighting to all 21 readings) the system may need to pre-process the motivation records. For example, by taking the arithmetic or geometric means of motivation records within windows e.g. weeks.

### Standardisation (Step 308)

Once individual models for the users are estimated, the system will standardise individual motivation records. For example, by calculating the z-score:

$$z = \frac{x - μ}{σ}$$

This provides a standardised value for motivation that takes into account both the average motivation level of the user and the variability in their levels. This can be used, as outlined below, to provide insight to individuals, but also as an input to the team motivation.

### Team Motivation/Aggregation (Step 309)

Once a set of standardised scores for a team is generated, the system may calculate an aggregate motivation measure for the team, for example by calculating the arithmetic mean of the standardised values (in this case a mean of means):

$${μ}_{t} = \frac{{\sum }_{i} {μ}_{i}}{n}$$

For the purposes of anonymity teams would have to consist of at least, for example three individuals.

This provides a team motivation score (and, as additional motivation records are collected and processed, a time series), which can be used for insights as detailed below. The summary statistics of this time series can also be used for insights.

### Additional Data (Step 310)

The system collects other information, at specific points in time, for future analysis against the Motivation Data. This data may be primarily unstructured, however, it is may always be timestamped as to when it was collected, allowing for chronological correlations to be made in the future. This data is referred to as Additional Data, and it may takes four forms: individual, team, local and global:

### Individual (311)

User-Specific Additional Data is associated with a given user through the storage of that user's unique identifier alongside the data to be stored. It can come from the app (such as Questions or Top3) or it can be sourced from a third-party database, when the system has a linked user identifier.

An example of this is collecting data about lifestyle from an application such as the Jawbone UP platform, which provides information as to the user's health and physical activity. To access that data, credentials for the system are required showing that the user has delegated Jawbone access to access their HTTP(S) API to the system.

### Team (312)

The system may record various team updates, such as new people joining a team, people leaving a team and so on. This allows the system to build time series of team events, for example the length of time since somebody joined the team or left the team (NB this would be an anonymous, team property; the joining or leaving of team would also be an individual's event).

The system may also link to third party, team related APIs in a similar manner to those for the individual.

### Local (313)

Data such as weather conditions, astrological states, recent events (for instance holidays or disasters), or transportation issues, etc. may be recorded with both a location and time in a database by the system.

### National/Global (314)

Generic information may include data about users companies (e.g., stock price, news occurrences, board changes, etc), or globally significant news.

All of the Additional Data may be stored separately from Motivation Data, however, would still be accessible during analysis and correlation of Motivation Data.

The collection of new Additional Data may happen in response to new Motivation Data being collected (for instance, a user submits motivation scores, so the system collects the users' fitness data or check their company's stock price). It may also come in via the internet through an API that the system exposes to other applications, such as third party applications.

Significant pre-processing of the data may be required. This could include normalising quantitative data for input to machine learning algorithms, construction of quantitative time series from events (for example time since last public holiday) and data alignment with, for example, weekly motivation data.

Some of the additional data, while timestamped, may not be temporally meaningful: for example the answers to some Binary Questions. This may however be useful in drawing conclusions between users or clustering users.

### Correlations (Step 315)

Once the system obtains and standardises motivation readings and obtains and pre-processes additional data, it can perform correlation analysis of this data. In one embodiment, the correlation analysis may ignore the time series nature of the data and look for straightforward positive or negative correlations.

Having identified strong correlations with motivation data the system can estimate a statistical model relating the motivation data to the other data set(s).

When viewing the datasets as time series, the system may, for example, attempt to identify where one dataset lags another. The system can also perform predictive analyses via machine learning as described below:

### Regression Analysis (316)

In order to model relationships between datasets, the system may fit statistical models. Typically, the system may be most interested in understanding what affects motivation and how strongly. So the dependent variable in such analyses would be the (standardised) motivation score. The independent variables would be the windowed, (possibly) normalised additional data variables. With this data, the system can apply standard regression algorithms (for example Ordinary Least Squares, Ridge Regression) to fit models. This process gives the key results of a statistical significance of each result, a size (how large an effect) and a sign (is the effect positive or negative). These insights can be delivered to users, teams and globally as insights as detailed below.

In these kinds of analyses, the system ignores the time series structure of the data.

The data can be combined from many individuals to estimate global models and considered as individuals and team's data separately.

### Predictive Time Series Analysis (317)

In performing time series analysis, the system has to cope with specific aspects of the data. For example, motivation patterns changing over time, new team members joining, or old members leaving.

Example of pre-processing steps may include the calculation of the first differences (i.e. the change in values from previous values) and the removal of new members from the team values (for the purposes of estimating the impact of the new member joining while not including their direct motivation effects).

### Clustering (318)

With the binary questions, the system has a high dimensional, but binary dataset which can be used to cluster users. This may allow the identification by the system of subsets of users who behave in similar ways; or for whom similar conclusions from regression analysis hold. For the dataset generated, for example, a k-Medians clustering algorithm may be appropriate. There may be potential issues with different users answering different questions (e.g. leading to missing values); but if questions are ordered it can be ensured that users have answered at least as many questions as the one who has answered the fewest.

### Insight (Step 319)

Insights may be generated from the correlations step and may be represented through the use of Graphs, Tables, Infographics, or Copy or other formats of communicating information. The sharing of insights may happen through the use of emails or push notifications to mobile devices. Insights may utilise correlations from external or internal data sources, or a combination of both.

Having obtained standardised motivation data, the additional data, including the various forms described above, and the results of the correlation and machine learning analyses, the system may generate insights for various users. The insights may be rescaled or converted from quantitative to categorical values for ease of comprehension. In particular, the system could use a scale of 0-100 (or whatever scale is used for the motivation selection) to present normalised results.

### Individual Insights (Step 320)

The app on their user device presents individuals with easily understood summary data such as their last, average, highest and lowest motivation values.

Additionally graphs could show how a user's motivation has varied over time and show values average by day, week, month or other time window and how this varies over time. The notes provided by the user at the point of providing their motivation value may be represented on this graph as a visual icon such as an asterisk. This may assist the user in showing which motivation values are associated with notes and the note may be displayed to the user upon actuation of the icon.

Additionally, or alternatively, a simple categorical state could be presented, for example:

“today your motivation is high”.

The results from correlation, regression or other analyses may presented by the app in an accessible manner. For example:

“pollen count appears to affect your motivation” or
“on days when you exercise your motivation is higher”.

These could, when appropriate, be presented in graphical form, particularly for seasonal effects; or via quantitative estimates, for example:

“your motivation is around 5 points higher on days when you work from home”.

### Team Insights (Step 321)

The system may present to team managers and members an overview of their team using the standardised and aggregated results as produced by the processed outlined above.

The results could be presented in a similar manner to individual results. For example:

“this week motivation is high” or
“towards the end of the week your team's motivation is higher”.

Additional team insights could include how varied the motivation is in the team.

These results may be for aggregate data (to ensure that a manager does not see individual data). If an insufficient number of motivation recordings have been made within, for example, a week, it is possible some or all of these insights will have to be kept hidden because they may reveal individual data.

### National/Global Insights (Step 322)

From the global dataset, a number of results could be presented to all users.

When presented to users the form could be along the lines of:

“exercise tends to improve motivation”.

Where there is a globally observed relationship the system could scale the effect, taking into account the variability and average motivation an individual to present the result in a quantified way, specific for that user. For example:

“We expect your motivation to be around 5 points lower this Winter”.

The results of clustering may also be used to divide the global user base into subsets for whom more accurate insights can be provided.

### Questions (301b)

Within the individual user's app, the user may be prompted to answer simple binary questions. These questions will be stored by the system in a database and may be used for further correlation analysis, insight into individual users and for clustering of users. The answers to these questions are stored as User-specific Additional Data.

Answers will store the unique identifier for the question, the unique identifier for the user answering, along with their binary response (Yes/No, True/False). If a user skips a question, then the system may store the fact that they skipped, instead of storing the binary response.

e.g. The question “do you think duvet days are a good idea?” identified by d79ca123-9f18-42fe-a9e7-cef0cd90d081 would be presented to the user identified as d924ce56-4493-4337-8770-1d697050003b through the app. On screen, the user would see the question text, followed by three buttons: Yes, No, and Skip. If a user answers yes then the JSON representation of the data recorded in the database may be:

```
{
  user_id: “d924ce56-4493-4337-8770-1d697050003b”,
  question_id: “d79ca123-9f18-42fe-a9e7-
cef0cd90d081”
  skipped: false,
  response: true,
  timestamp: 1424197076000
}
```

A recording may be separately stored of other sensor data related to the answering of the question by the combination of user_id and timestamp.

### Top3 (301c)

Within the individual user's app, the user may be prompt to record their top three highlights and challenges of the week along with their top three goals for next week. The input for Top3 is in the form of three text values, in which a user can write anything they desire. However, there may be a soft character limit alerting users if they have typed in too much (256 characters is suggested limit). This may assist in encouraging employees to be precise and concise.

The Top3 data may stored separately from the rest of the system's databases, and persists only for as long as needed to send aggregate reports, or to check if the user had completed their goals from the previous week.

Instead of using this data to generate correlation information, the system makes a record as to whether Top3 was submitted, and if so, whether it was fully completed or only partially completed. These records are stored as User-specific Additional Data, and take the form of, for example:

```
{
  user_id: “d924ce56-4493-4337-8770-1d697050003b”,
  timestamp: 1424197076000,
  highlight_count: integer(0-3),
  challenge_count: integer(0-3),
  goal_count: integer(0-3),
  submitted: true
}
```

If a user fails to submit Top3 by the time at which Top3 submissions close for the week, the following may be recorded, for example:

```
{
  user_id: “d924ce56-4493-4337-8770-1d697050003b”,
  timestamp: 1424198036000,
  highlight_count: 0,
  challenge_count: 0,
  goal_count: 0,
  submitted: false
}
```

One potential advantage of requiring users to provide answers to Top3 is that not only does it help teams improve communication and help the user to reflect and think about what they need to accomplish, but it also acts as a mechanism to ensure motivation values are regularly captured, and all employees can be instructed/encouraged to complete the Top3 on a weekly basis.

Once the Top3 deadline has passed the system will correlate all Top3 recordings from individual users within the same team then send a single update email to the team's designated manager. This will include the users' name when displaying the Top3 data.

The email may also provide information as to number of team members who skipped Top3, or changes to the team's structure, for instance new team members or people leaving the team.

FIGS. 4a, 4b, and 4c show different user interface mechanisms for capturing motivation values from a user in accordance with an embodiment of the invention.

FIG. 4a illustrates a gauge where a user swipes an indicator 400 left and right within a range to modify a value between 0 and 100. The user can also add a note for the motivation value by pressing 401. Notes allow a user to enter a description of what was influencing their motivation at that point in time. This may be used by the system to display these notes back to the user, when the user is exploring their historical motivation levels.

FIG. 4b illustrates an alternative mechanism, specifically a dial, for capturing a motivation value and note from the user.

FIG. 4c illustrates an alternative dial.

FIGS. 5a, 5b, and 5c illustrate the capture of notes for each motivation value in accordance with an embodiment of the invention.

FIG. 5a highlights where the add note button is.

FIG. 5b illustrates how a note would be entered.

FIG. 5c illustrates the display of a summary 500 of the note once entered for some devices. For other devices, a summary of the note may not possible due to the limitation in screen space on those devices. Where this occurs the ‘ADD A NOTE’ button may change to ‘EDIT NOTE’ along with its colour (for example, a change from orange to green).

The following are examples of notes that may be provided by a user:
“Had an amazing presentation and feel great”
“Just won a new bit of business after some really hard pitching”
“Not feeling confident about where I currently am in my job following a negative review.”

As can be seen above, these notes can be both positive and negative.

FIGS. 6a, 6b, 6c, 6d, and 6e illustrate the capture of specific information relating to an employee's tasks in accordance with an embodiment of the invention.

In this embodiment, the specific information will be referred to as Top3. In Top3, three questions are asked, and three inputs are required from the user in relation to each question.

FIG. 6a illustrates the app in a waiting state. This occurs when the motivation values are captured periodically and indicates that the Top3 information is not yet required from the user. A count-down is shown to the user. At the expiry of the count-down, the user will be able to provide their Top3 information.

FIG. 6b illustrates the app when the count-down has expired. The user is prompted to begin entry of their Top3 information.

FIG. 6c illustrates the provision of text data by the user to answer the Top3 questions.

FIG. 6d illustrates the capture of a motivation value from the user using a gauge user interface mechanism which occurs after the Top3 answers have been provided.

FIG. 6e illustrates the screen displayed when the motivation value and Top3 answers have all been provided.

FIGS. 7a and 7b illustrate the posing and answering of a binary question in accordance with an embodiment of the invention.

FIG. 7a illustrates the asking of a binary question—in this example, “Do you think duvet days are a good idea?”, of the user. The user can select the tick box to agree or the X box to disagree.

FIG. 7b illustrates an output provided to the user on the basis of their answer. In this example, the percentage of users agreeing with the user is 86%.

FIGS. 8a, 8b, 8c, and 8d illustrate the calibration for a user in accordance with an embodiment of the invention.

The mobile application on the user's device may prompt for calibration when the user first registers with the system.

On signing up the user enters their registration details (for example, a work activation code). After which the user is asked four calibration questions by the mobile application:
1. On a scale of 0% to 100% what is your current motivation?
2. In the last three months, roughly what was your highest motivation?
3. In the last three months, roughly what was your lowest motivation?
4. What would you like your motivation to be on average?

The answers to these questions can be used by the system to compute the initial Range of motivation and the potential Swing area that the motivation score will move between. It also allows the system to correlate an average base level across different Employees within a company. An example of this is one Employee's average may be 68% while another is 78%, both are average but there is a ten point difference. For some analysis, the system may calculate both Employees as 10 on a 20 point scale (therefore both being average). This allows for more accurate benchmarking and analytics then adding the Employees scores together then dividing the number of employees to calculate an average motivation score. It also harmonises high scores with low scores (e.g. some Employees will naturally enter higher numbers than others, however, in reality and from a mathematical point of view they have exactly the same motivational levels). By combining the Range, Swing and Motivational score together motivation can be monitored more accurately over time.

Referring to FIG. 9, a method 900 in accordance with an embodiment of the invention will be described.

In step 901, calibration information is captured from a user and provided to a server. The calibration information may include a value representing the user's current motivation level, the user's estimation of their highest motivation level in a last set period of time, the user's estimation of their lowest motivation level in the last set period of time, and/or the user's estimation of what they would like their motivation level to be at. The set period of time may be, for example, three months.

In step 902, a motivation value is captured from the user and provided to the server via a user device. Step 902 may occur significantly after step 901 and may be repeated multiple times without step 901 being repeated.

In step 903, the server normalises the motivation value captured utilising the previously provided calibration information.

In step 904, the server may process the normalised motivation values to generate analysis. The analysis may be represented as averages of motivation over a period of time, graphs of historical motivation values, differences in current motivation from the user's average motivation (or average motivation of a group of users), and rates of change in motivation over time. The analysis may be delivered to the user.

In step 905, the normalised motivation values of a plurality of users (such as members of a team) may be aggregated.

In step 906, the server may process the aggregated values to generate analysis. The analysis may be represented as averages of motivation over a period of time, graphs of historical motivation values, differences in current motivation from the group of users' average motivation, and rates of change in motivation over time. The analysis may be delivered to a manager of the group of users.

FIGS. 10a, 10b, 10c, and 10d illustrate the display of analysis to a user based upon their entered motivation values in accordance with an embodiment of the invention.

FIG. 10a illustrates a dashboard displayed to a user showing the user's last, average, lowest, and highest motivation value for a period of time.

FIGS. 10b, 10c, and 10d illustrate gauges of which one will be displayed to a user showing their current motivation at their desired level, below their desired level, and above their desired level respectively.

Referring to FIG. 11, the display of information/analysis to a manager based upon the provided motivation values in accordance with an embodiment of the invention will be described.

This embodiment of the invention provides anonymised information on groups to a manager or senior person within an organisation. Groups are anonymised groupings of three or more individuals (employees/members of the organisation). These groups may be teams, divisions, job types, tenure of employment, location, seniority, gender, etc. On viewing one single group insight/analysis may be displayed in a similar format to what an individual user is shown in FIGS. 10a to 10d. However, the manager may also compare multiple groups.

This embodiment of the invention normalises where an individual is within their own motivation recording and converts this into banding that can be used for comparison of individuals, teams, roles, organisations, countries and more, for example, using standard deviation.

This embodiment of the invention utilises calibration data provided by the user (as described in relation to FIG. 9) to calculate the desired motivation level for individual groups to enable accurate comparison of teams with each other.

This embodiment may attribute the following values to an individual in relation to where they are in their range:

10% above their desired motivation: 10 points

Within 10% on their desired motivation: 0 points

10% below their desired motivation: −10 points

It will be appreciated that the “10%” range is exemplary only.

Desired motivation may be assigned an arbitrary 100 points. The points system allows this embodiment to add up all the individual points within any size of group and turn it into a % to calculate if that group is above or below their desired motivation. If the group scores below 95% they are below their desired level if they score 105% and above, they are above their motivation desire as a group.

This embodiment can then use this to compare multiple groups with each other as well as enabling the plotting of groups' motivation on a graph over time where desire is the Y axis and X is the time as shown in FIG. 11.

It will be appreciated that the aspects shown and described in relation to any of the above figures can be combined together in a number of variations to form embodiments of the invention.

A potential advantage of some embodiments of the present invention is that superior business intelligence can be provided to managers and a business by correlating other data sources with employee's motivation. Other potential advantages of some embodiments of the present invention is that periodically captured motivation values can provide insight about the effects of time-based causes on motivation, capturing information relating to an employee's tasks alongside motivation improves the relevance of motivation data captured, and normalising the motivation data on a per user basis improves standardisation of the results over time.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1.-59. (canceled)

60. A computer-implemented method of providing a management tool, including:
Capturing a motivation value from each of a plurality of users via a user device; and
At least one processor processing the captured motivation values with data from one or more data sources to generate correlation information.

61. A method as claimed in claim 60, wherein the motivation values are captured periodically.

62. A method as claimed in claim 60, wherein a user is given a predefined window within which to provide the motivation value.

63. A method as claimed in claim 60, wherein the motivation values are within a predefined range.

64. A method as claimed in claim 60, further including:
at the time of capturing the motivation value, capturing specific information relating to the user's tasks via the user device.

65. A method as claimed in claim 60, wherein at least one of the data sources is an external data source.

66. A method as claimed in claim 60, wherein at least one of the data sources is a data source from a company of which at least some of the users are employees.

67. A method as claimed in claim 60, wherein one of the data sources is the user device.

68. A method as claimed in claim 60, wherein at least some of the data from the one or more data sources is global/national data.

69. A method as claimed in claim 60, wherein at least some of the data from the one or more data sources is local data.

70. A method as claimed in claim 69, wherein the local data is one or more selected from weather, transport, and date.

71. A method as claimed in claim 60, wherein at least some of the data from the one or more data sources is user specific data.

72. A method as claimed in claim 71, wherein the user specific data is one or more selected from fitness data, and geolocation data.

73. A method as claimed in claim 60, further including:
Capturing calibration data from each user in relation to their motivation.

74. A method as claimed in claim 60, further including:
Prior to processing, normalising the motivation values.

75. A method as claimed in claim 74, further including:
Capturing calibration data from each user in relation to their motivation.
wherein the step of normalising the motivation values utilises the calibration data.

76. A method as claimed in claim 60, further including:
at the time of capturing the motivation value, capturing information relating to the motivation value from the user via the user device.

77. A method as claimed in claim 60, further including:
Pre-processing the data retrieved from the one or more data sources before use in generating correlation information.

78. A method as claimed in claim 77, wherein the pre-processing includes normalising the data, generating a quantitative time series, and/or aligning the data.

79. A system for providing a management tool, including:
A plurality of user devices, each device configured to capture motivation values from a user;
At least one processor configured to process the captured motivation values with data from one or more data sources to generate correlation information; and
At least one memory store configured to store the captured motivation values.

80. A computer-implemented method of providing a management tool, including:
Capturing a motivation value from each of a plurality of users via a user device;
At least one processor normalising the motivation value for each user utilising calibration information previously provided by that user; and
At least one processor processing the normalised motivation values to generate analysis.

81. A system for providing a management tool, including:
A plurality of user devices, each device configured to capture motivation values from a user;
At least one processor configured to normalise the motivation value for each user utilising calibration information previously provided by that user and to process the normalised motivation values to generate analysis; and
At least one memory store configured to store the normalised motivation values.
